(19) United States
(12) Patent Application Publication
(10) Pub. No.: US 2003/0233291 A1
(43) Pub. Date: Dec. 18, 2003

(54) System and method for managing cargo shipment

(76) Inventors: Michael Hsu, Shenzhen (CN); TangHao Chu, Shenzhen (CN); ZhiGang He, Shenzhen (CN); Simon Shen, Shenzhen (CN); Bao Zhong Xu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/172,630

(22) Filed: Jun. 13, 2002

(51) Int. Cl. G06F 17/60

(52) U.S. Cl. 705/28

(57) ABSTRACT

A system and method for managing cargo shipment according to inventory status and a received purchase order. The system interchanges data with a carrier MIS (5) and a customer MIS (4) via an EDI value added network (2). The system includes a main database (16) for storing purchase order data and inventory data, and a plurality of user clients (11) electronically connected with the main database. Each user client includes a shipment data management unit (12) for handling the data stored in the main database. The shipment data management unit includes a purchase order data search module (120) for users to search for the data on purchase orders set by customers, an inventory data search module (122) for users to search for inventory data relevant to the purchase orders, and a shipment schedule module (124) for scheduling shipment of cargo according to the purchase order data and the inventory data.

### BACKGROUND OF THE INVENTION

1. Field of the Invention

This invention relates to systems and methods for managing cargo shipment, and more particularly to systems and methods which can schedule shipment of cargo according to inventory data and purchase order data received.

2. Description of Related Art

With recent advances in communications technology, traditional methods of data interchange between enterprises are gradually being replaced by the use of electronic data such as EDI and web technology. More and more enterprises are adopting such electronic data to improve their working efficiency and cut down operating costs. One important field concerned is the transmission of purchase and sales order data and cargo shipment data, which are conventionally transmitted by post or fax. Typically, a customer sends purchase order data having a standard EDI format to a supplier. The supplier then schedules production and shipping according to the purchase order data. When the cargo required by the purchase order is manufactured and ready, the supplier sends an EDI shipping information message to the customer. The customer then collects the cargo at a designated time.

Cargo delivery from the supplier to the customer is invariably handled by a carrier. The carrier may be an independent transportation company, or a shipping department of the supplier or of the customer. A carrier generally has a warehouse located relatively near the customer's premises. Some carriers provide temporarily storage of cargo, and subsequent delivery once the customer requires the cargo. The carrier needs to be involved in the cargo delivery data interchange between the supplier and the customer.

In addition, although many enterprises have an independent EDI system for interchanging data with their suppliers and customers, few enterprises integrate their EDI system with their internal management information system (MIS). As a result, scheduling of production and shipping according to current inventory and customers' orders is inconvenient and inefficient.

Accordingly, what is needed is a system and method which can overcome the abovementioned problems.

### SUMMARY OF THE INVENTION

A primary object of the present invention is to provide a system which can efficiently schedule shipment of cargo according to inventory data and purchase order data received.

Another object of the present invention is to provide a method which can efficiently schedule shipment of cargo according to inventory data and purchase order data received.

To achieve the above-mentioned primary object, a system of the present invention for managing cargo shipment comprises a main database for storing purchase order data and inventory data; and a plurality of user clients electronically connected with the main database. Each user client comprises a shipment data management unit for handling the data stored in the main database. The shipment data management unit comprises a purchase order data search module for users to search for data on purchase orders sent by customers, an inventory data search module for users to search for inventory data relevant to the purchase orders, a shipment schedule module for scheduling shipment of cargo according to the purchase order data and the inventory data, and a reporting module for generating reports on shipment.

To achieve the other above-mentioned object, a method of the present invention for managing cargo shipment comprises the following steps: receiving purchase order data from a customer; searching for inventory data in a main database according to the purchase order data; listing inventory data corresponding to the purchase order data; selecting inventory to fulfill the purchase order, by prioritizing according to production date; sending selected inventory data and the purchase order data to a shipping organization; and sending a cargo shipment message to the customer according to the inventory data and the purchase order data.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a schematic diagram of a framework of an EDI data exchange system incorporating a system for managing cargo shipment according to a preferred embodiment of the present invention, together with a carrier management information system (MIS), a customer MIS, an EDI value-added network (VAN) and an internal MIS;

FIG. 2 is a schematic diagram showing data exchange between the EDI data exchange system, the carrier MIS and the customer MIS;

FIG. 3 is a flowchart of sending of data from the EDI data exchange system to the customer MIS and the carrier MIS;

FIG. 4 is a schematic diagram showing main application modules of a shipment data management unit of the EDI data exchange system;

FIG. 5 is an exemplary computer interface showing data on cargo shipment;

FIG. 6 is an exemplary computer interface showing a shipping report generated by a reporting module of the shipment data management unit; and

FIG. 7 is a flowchart for implementing the shipment data management unit.

### DETAILED DESCRIPTION OF THE INVENTION

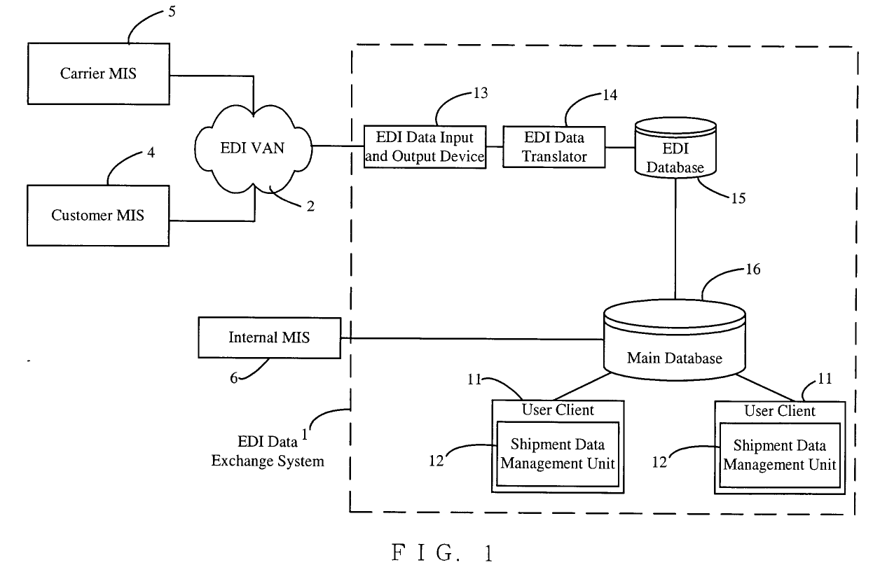

FIG. 1 illustrates a framework of an EDI data exchange system 1 incorporating a system for managing cargo shipment according to a preferred embodiment of the present invention. The EDI data exchange system 1 comprises a plurality of user clients 11, an EDI data input and output device 13, an EDI data translator 14, an EDI database 15, and a main database 16. The system for managing cargo shipment comprises the plurality of user clients 11, and the main database 16. An internal management information system (MIS) 6 is electronically connected with the main database 16 for providing required data to the main database 16. The internal MIS 6 can be an information system which includes data on procurement, production and sales of a factory. The main database 16 is provided for storing data related to the factory as well as data related to its customers and suppliers. The EDI database 15 is a relational database, and is provided for temporarily storing data that are received from or sent to an external system. The EDI data translator 14 provides the function of inter-converting between a format of EDI data and a format of the data stored in the relational database. The EDI input and output device 13 is provided for sending EDI data to or receiving EDI data from an EDI value-added network (VAN) 2. A plurality of customer management information systems (MISs) 4 (only one shown) and carrier MISs 5 (only one shown) can interchange EDI data with the EDI data exchange system 1 via the VAN 2. Each carrier MIS 5 is implemented in a carrier organization. The carrier organization may be an independent company, or a shipping department of the factory. The carrier organization's premises are preferably located near the customers, and are for helping the factory to transport manufactured cargo to the customers.

The user clients 11 are provided for searching and managing the data stored in the main database 16. Each user client 11 comprises a shipment data management unit 12 for controlling all activities related to cargo shipment. Authorized users can electronically visit the main database 16 and send relevant requirements regarding performance of cargo shipment via the shipment data management unit 12.

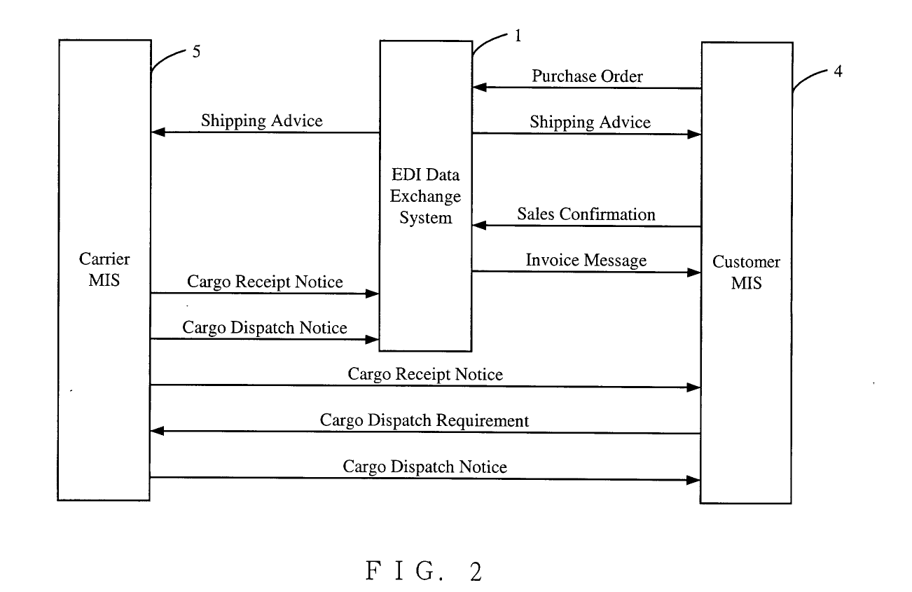

FIG. 2 is a schematic diagram showing data exchange between the EDI data exchange system 1, one carrier MIS 5 and one customer MIS 4. At first, a customer sends purchase order data to the EDI data exchange system 1 via the customer MIS 4. After receiving the purchase order data, the EDI data exchange system 1 sends a shipping advice message to the customer MIS 4 and the carrier MIS 5. The shipping advice complies with requirements of the purchase order, and is generated according to inventory and production status. The shipping advice is for notifying the carrier and the customer of the shipping date and other relevant information relating to the cargo shipment. When the carrier receives the cargo at a destination designated by the purchase order, the carrier MIS 4 sends a cargo receipt notice to the EDI data exchange system 1 and the customer MIS 4. The cargo is then temporarily stored in the carrier's warehouse until the customer requires it. When the customer requires the cargo, the customer MIS 4 sends a cargo dispatch requirement to the carrier MIS 5. After the carrier dispatches the cargo, the carrier MIS 5 sends a cargo dispatch notice to the customer MIS 4 and the EDI data exchange system 1. When the customer receives the cargo, the customer MIS 4 sends a sales confirmation message to the EDI data exchange system 1. Finally, after the purchase order is fulfilled, an invoice message is sent to the customer MIS 4 for payment by the customer.

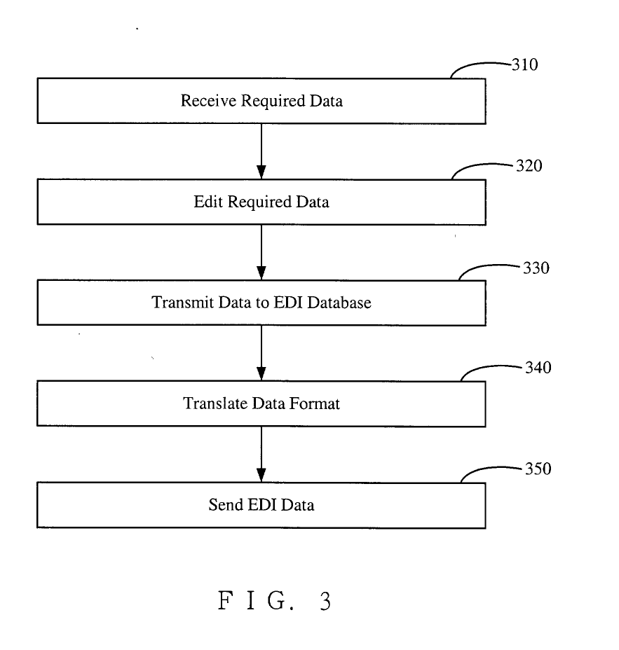

FIG. 3 is a flowchart of sending of data from the EDI data exchange system 1 to any customer MIS 4 and any carrier MIS 5. In step 310, the data required to be sent to the customer or the carrier are received from the internal MIS 6 and stored in the main database 16. In step 320, an authorized user edits the required data stored in the main database 16 via the shipment data management unit 12 of the user client 11. In step 330, the required data are transmitted to and temporarily stored in the EDI database 15, which then transmits them to the EDI data translator 14. In step 340, the EDI data translator 14 translates the data into standard EDI format. In step 350, the EDI data input and output device 13 sends out the EDI data via the EDI VAN 2.

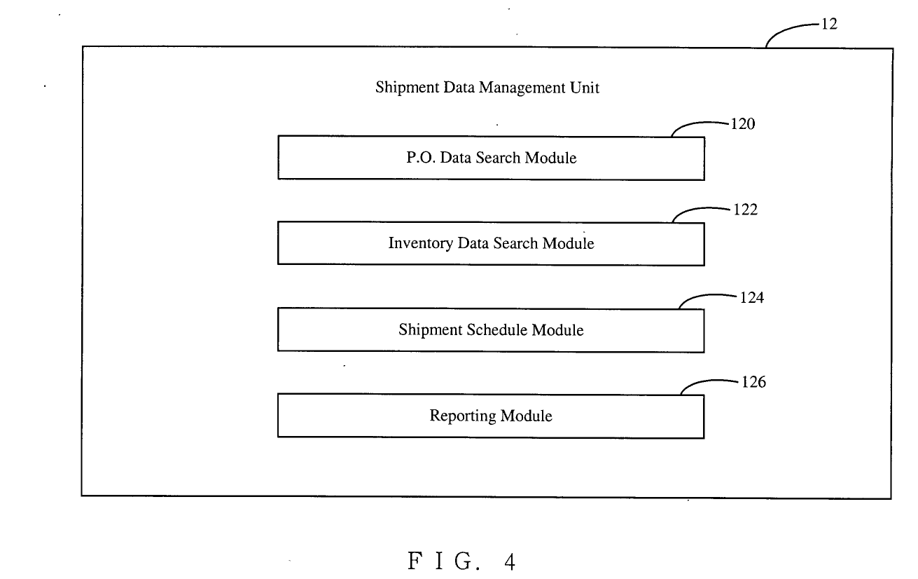

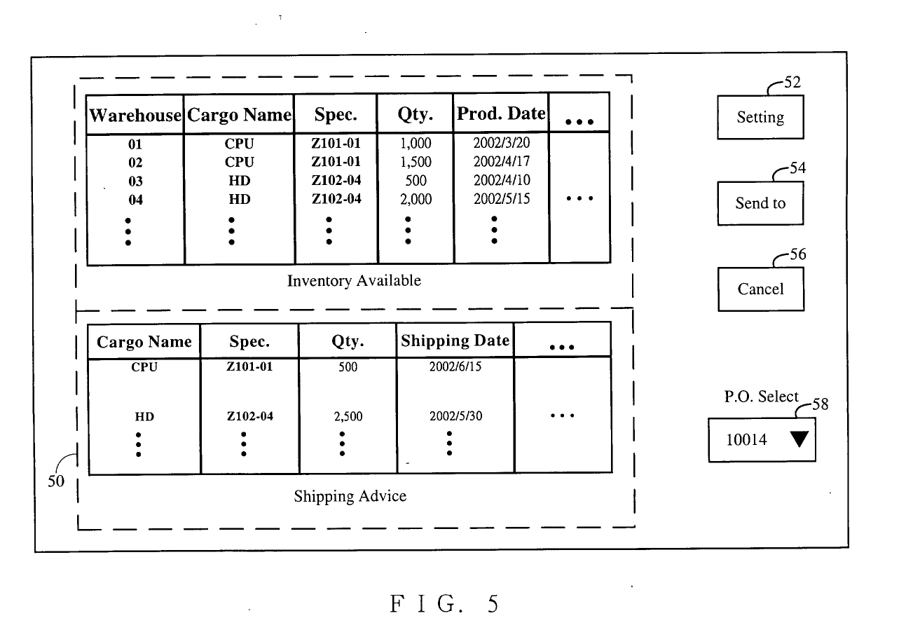

FIG. 4 is a schematic diagram showing main application modules of each shipment data management unit 12. The shipment data management unit 12 comprises a purchase order (P.O.) data search module 120 provided for users to search for data on purchase orders sent by customers, an inventory data search module 122 provided for users to search for inventory data relating to purchase orders, a shipment schedule module 124 for scheduling shipment of cargo according to the purchase orders and the inventory data, and a reporting module 126 for generating reports on shipment. Purchase order data are received by the EDI data exchange system 1 and stored in the main database 16. Inventory data are transmitted to the main database 16 from the internal MIS 6. Authorized users can obtain data on purchase orders and inventory from the main database 16 via the P.O. data search module 120 and the inventory data search module 122. When a purchase order is received, the shipping schedule module 124 checks data in the purchase order against inventory data, and schedules a shipment date accordingly. A detailed description of the shipping schedule module 124 is given below with reference to FIG. 5.

FIG. 5 is an exemplary computer interface showing data on cargo shipment. A data display area 50 is provided for displaying data on inventory and on shipment. Users can display a shipping advice for a purchase order as well as data on inventory available to fulfill the purchase order. The shipping advice data shown in the data display area 50 comprises items such as cargo name, specification, quantity, and shipping date. The inventory data shown in the data display area 50 comprises items such as the warehouse that stores the cargo required by the purchase order, cargo name, specification, quantity, and production date. A “setting” icon 52 is provided for users to select items for display in the data display area 50. That is, users can select data to be shown in the data display area 50 according to their particular requirements. For example, a user can display only data on the shipping advice, for subsequent transmission to a customer. Similarly, a user can display both data on the inventory and on the shipping advice. This would be for subsequent transmission to the shipping department of a factory that is in charge of accessing warehoused cargo and arranging shipment. Users can also select individual items displayed in the shipping, advice data and the inventory data. A “send to” icon 54 is provided for users to send the data displayed in the data display area 50 to customers, production departments, shipping departments, or other relevant recipients. A “cancel” icon 56 is provided for users to cancel a selected item in the data display area 50. A “P.O. select” icon 58 is provided for users to select a purchase order. When a purchase order is selected, data on the purchase order are displayed in the shipping advice data in the data display area 50. Inventory data corresponding to that purchase order can also be displayed in the data display area 50, by using the “setting” icon 52. For example, inventory and shipping advice data shown on the data display area 50 can be sent to production departments and shipping departments. The production departments can arrange production and the shipping departments can arrange shipment according to the data received.

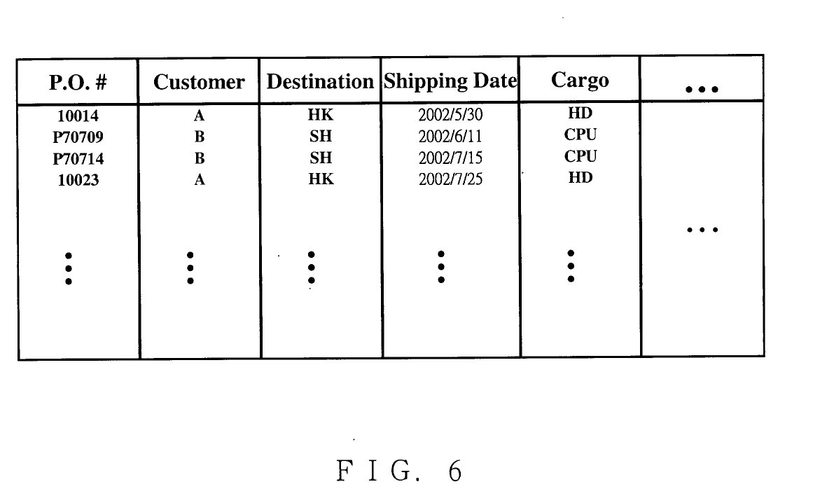

FIG. 6 is an exemplary computer interface showing a shipping report generated by the reporting module 126 of the shipment data management unit 12. The report is generally provided to shipping departments and other relevant recipients, and comprises data on cargo shipped during a designated period. For example, the designated period may be one week. The data shown on the report include items such as purchase order number, customer, destination, shipping date, and type of cargo.

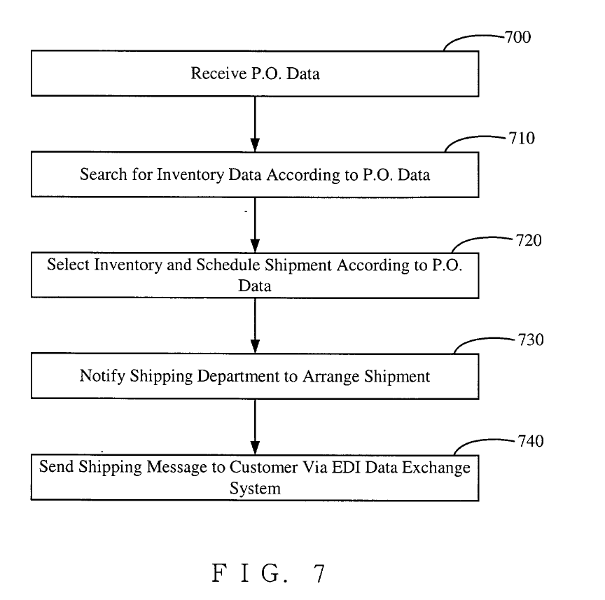

FIG. 7 is a flowchart for implementing the shipment data management unit 12. In step 700, data relating to a purchase order are received by the data exchange system 1 and stored in the main database 16. In step 710, a user searches for inventory data according the received purchase order data, via the shipment data management unit 12. Inventory corresponding to the purchase order is listed and displayed on the user client 11. In step 720, the shipment data management unit 12 automatically selects inventory, and schedules shipment according to the purchase order and the inventory data. Generally, inventory having an earlier production date is prioritizedly selected to fulfill the purchase order. If the inventory is sufficient to fulfill the purchase order, the shipment is scheduled according to the purchase order and the selected inventory is marked as “shipped” in the main database 16. When another purchase order is received by the EDI data exchange system 1, the inventory marked as “shipped” is not listed in the search result. If the inventory is not sufficient to fulfill the purchase order, some cargo needs to be produced before the shipping date specified in the purchase order. In step 730, the purchase order data and corresponding inventory data are sent to the relevant production department and shipping department for arranging of production and shipment. In step 740, relevant data on cargo shipment are sent to the customer via the EDI data exchange system 1.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for managing cargo shipment, comprising:
a main database for storing purchase order data and inventory data; and
a plurality of user clients electronically connected with the main database, each of the user clients comprising a shipment data management unit for handling the data stored in the main database, wherein the shipment data management unit comprises a purchase order data search module for users to search for data on purchase orders sent by customers, an inventory data search module for users to search for inventory data relevant to the purchase orders, and a shipment schedule module for scheduling shipment of cargo according to the purchase order data and the inventory data.

2. The system as claimed in claim 1, wherein the shipment data management unit further comprises a reporting module for generating reports relating to cargo shipment.

3. The system as claimed in claim 1, wherein the main database electronically connects with an internal management information system and receives inventory data therefrom.

4. A method for managing cargo shipment, comprising the following steps:
receiving purchase order data from a customer;
comparing inventory data in a main database with the purchase order data;
selecting inventory to fulfill the purchase order, by prioritizing according to production date; and
sending selected inventory data and the purchase order data to a shipping organization.

5. The method as claimed in claim 4, further comprising the step of:
listing all the inventory data corresponding to the purchase order data.

6. The method as claimed in claim 4, further comprising the step of:
marking in the main database the selected inventory as shipped inventory.

7. The method as claimed in claim 4, further comprising the step of:
sending the selected inventory data and the purchase order data to a production department when inventory is not sufficient to fulfill the purchase order.

8. The method as claimed in claim 4, further comprising the step of:
sending a cargo shipment message to the customer according to the inventory data and the purchase order data.

9. A method for managing cargo shipment, comprising the following steps:
receiving purchase order data from a customer;
searching for inventory data in a main database according to the purchase order data;
listing inventory data corresponding to the purchase order data;
selecting inventory to fulfill the purchase order, by prioritizing according to production date;
sending selected inventory data and the purchase order data to a shipping organization; and
sending a cargo shipment message to the customer according to the inventory data and the purchase order data.

10. The method as claimed in claim 9, further comprising the step of:
sending the selected inventory data and the purchase order data to a production department when inventory is not sufficient to fulfill the purchase order.
